(19) United States
(12) Patent Application Publication
(10) Pub. No.: US 2026/0274046 A1
(43) Pub. Date: Sep. 17, 2026

(54) UNIT COOLER

(71) Applicant: KABUSHIKI KAISHA TOYOTA JIDOSHOKKI, Aichi (JP)

(72) Inventors: Riichiro SANO, Aichi (JP); Hisaya KONDO, Aichi (JP); Kenji YAMAMOTO, Aichi (JP); Yuta ISHIDA, Aichi (JP); Shun KUBOTA, Aichi (JP)

(73) Assignee: KABUSHIKI KAISHA TOYOTA JIDOSHOKKI, Aichi (JP)

(21) Appl. No.: 19/168,111

(22) PCT Filed: Jan. 18, 2024
(86) PCT No.: PCT/JP2024/001256

§ 371 Date: Sep. 23, 2025

(30) Foreign Application Priority Data
Mar. 28, 2023 (JP) 2023-051868

(51) Int. Cl. B60H 1/32; B60H 1/00

(52) U.S. Cl. CPC B60H 1/3229; B60H 1/00357; B60H 1/00428; B60H 1/3222; B60H 2001/3286

(57) ABSTRACT

A unit cooler includes a housing and an air conditioner. The housing has a base plate having a through hole and an under cover fastened to the base plate with fastening members. A drain passage is recessed in the under cover and located under the through hole. The air conditioner has an electric compressor, a condenser, a decompression device, an evaporator, a first fan, a second fan, and a control device. The fastening members include pairs of first fastening members, second fastening members, and third fastening members. The through hole is open at a position overlapping an intersection point of diagonal lines connecting the second fastening members and the third fastening members.

### TECHNICAL FIELD

The present invention relates to a unit cooler.

### BACKGROUND ART

A conventional unit cooler is disclosed in Patent Literature 1. This unit cooler is used in an industrial vehicle such as a forklift truck, which has a power supply.

This unit cooler in Patent Literature 1 includes a housing and an air conditioner that is accommodated in the housing. The air conditioner has an electric compressor, a condenser, a decompression device, an evaporator, and a control device and forms a refrigeration cycle. The evaporator has a discharge duct. The housing has a first cover in which the electric compressor, the condenser, the decompression device, and the evaporator are accommodated, a second cover in which the control device is accommodated, an attachment plate, and a flat plate. The first cover in which the electric compressor, the condenser, the decompression device, and the evaporator are accommodated and the second cover in which the control device is accommodated are fixed to the attachment plate with bolts. The flat plate is fixed to the industrial vehicle with the bolts. Anti-vibration rubber is provided between the attachment plate and the flat plate, and the attachment plate, the anti-vibration rubber, and the flat plate are fixed with the bolts.

In this unit cooler, for example, in an industrial vehicle that does not have as many means for reducing vibrations as a passenger car, the electric compressor of the air conditioner is operated by a power supply to cool air, and the cooled air is supplied to an outside of the housing through the discharge duct. During this operation, the anti-vibration rubber suppresses that the vibrations while the industrial vehicle travels or operates are transmitted to the electric compressor or the like in the first cover and the control device in the second cover to reduce their failures. The anti-vibration rubber also contributes to quietness by absorbing the vibrations of the electric compressor.

### CITATION LIST

### Patent Literature

Patent Literature 1: Japanese Patent Application Publication No. H07-083464

### SUMMARY OF INVENTION

### Technical Problem

However, in the above-described conventional unit cooler, in a case where condensation water is generated in the air conditioner, the condensation water flows to the anti-vibration rubber, so that an electric current may flow to an outside of the housing through the anti-vibration rubber.

The present invention is made in view of the conventional circumstances described above and is directed to providing a unit cooler that may supply cold air to the outside of the housing and there is no risk of an electric current flowing to the outside of the housing even when the condensation water is generated in the air conditioner.

### Solution to Problem

A unit cooler of the present invention includes a housing and an air conditioner that is accommodated in the housing and is provided with a refrigeration cycle, the air conditioner cooling air and supplying the air to the outside of the housing. The unit cooler is characterized in that the housing has a base plate to which the air conditioner is fixed, the base plate having a through hole through which condensation water generated in the air conditioner is discharged, and an under cover that is disposed under the base plate and fastened to an outer peripheral portion of the base plate with a plurality of fastening members through an insulation member, a drain passage is recessed in the under cover and located under the through hole, the drain passage guiding the condensation water to an outside of the housing, and the drain passage is disposed at a predetermined distance from each of the plurality of the fastening members.

In the unit cooler of the present invention, the air conditioner forms a refrigeration cycle and cools air and supplies the air to the outside of the housing.

Also, in this unit cooler, the through hole is formed in the base plate to which the air conditioner is fixed, and the under cover disposed under the base plate is fastened to the outer peripheral portion of the base plate with the plurality of fastening members. The drain passage is recessed in this under cover and located under the through hole, the drain passage guiding the condensation water to the outside of the housing. Thus, when the condensation water is generated in the air conditioner, the condensation water drops onto the under cover from the base plate through the through hole and is discharged to the outside of the housing through the drain passage of the under cover. Here, since the drain passage is disposed at the predetermined distance from each of the plurality of the fastening members, the condensation water does not flow to the fastening members.

Accordingly, the unit cooler of the present invention may supply cold air to the outside of the housing, and in the unit cooler, there is no risk of an electric current flowing to the outside of the housing even when the condensation water is generated in the air conditioner.

Preferably, the under cover has an inclined surface that inclines so that the condensation water is guided from a side of each of the fastening members toward the drain passage. In this case, since the condensation water flows along the inclined surface by its own weight, the condensation water hardly flows to the fastening members, and the condensation water flows into the drain passage to be easily collected in the drain passage.

Preferably, the drain passage extends to at least one of ends of the under cover. In this case, the condensation water is easily discharged to the outside of the housing from the end of the under cover.

Preferably, the drain passage has an in-path inclined surface that guides the condensation water dropped through the through hole to the end of the under cover. In this case, the condensation water is easily collected in the drain passage and is easily discharged to the outside of the housing.

Preferably, the insulation member is made of rubber having a vibration isolating property. In this case, the insulation member suppresses that vibrations are transmitted to the air conditioner on the base plate to reduce failures of the air conditioner, and the insulation member absorbs the vibrations of the air conditioner to also contribute to quietness.

The air conditioner may have an electric compressor, a condenser, a decompression device, an evaporator, a first fan that sends air to the condenser, a second fan that sends air to the evaporator, and a control device that controls the electric compressor, the first fan, and the second fan. Preferably, the first fan adjacent to the condenser is disposed at one end of the base plate, the second fan adjacent to the evaporator is disposed at the other end of the base plate, and the electric compressor is disposed between the first fan and the second fan. In addition, the fastening members may include a pair of first fastening members that is disposed with the first fan interposed between the first fastening members, a pair of second fastening members that is disposed with the second fan interposed between the second fastening members, and a pair of third fastening members that is disposed with the electric compressor interposed between the third fastening members. Moreover, it is preferable that the through hole is open at a position that is overlapped with an intersection point of diagonal lines connecting the second fastening members and the third fastening members. In this case, even when a large amount of the condensation water is generated in the air conditioner, the condensation water hardly flows to each of the fastening members and easily drops onto the under cover through the through hole. Therefore, the effect of the present invention is likely to occur.

In a case where the air conditioner includes an accumulator, it is preferable that the accumulator is located in a region surrounded by the second fastening member and the third fastening member. In this case, an unnecessary space is less likely to be generated in the housing, so that the unit cooler may be decreased in size.

### Advantageous Effects of Invention

The unit cooler of the present invention may supply cold air to the outside of the housing, and in the unit cooler, there is no risk of an electric current flowing to the outside of the housing even when the condensation water is generated in the air conditioner.

### BRIEF DESCRIPTION OF DRAWINGS

FIG. 1 is a side view illustrating a forklift truck on which a unit cooler according to an embodiment is mounted.

FIG. 2 is an exploded perspective view illustrating the unit cooler according to the embodiment.

FIG. 3 is a plan view illustrating a state in which a top cover and an upper plate are removed from the unit cooler according to the embodiment.

FIG. 4 is a plan view illustrating an under cover in the unit cooler according to the embodiment.

FIG. 5 is a cross-sectional view illustrating a structure, the under cover, under rails, and the like in the unit cooler according to the embodiment.

FIG. 6 is a cross-sectional view illustrating the structure and the under cover in the unit cooler according to the embodiment as viewed in a direction different from a direction in which they are viewed in the FIG. 5.

FIG. 7 is a cross-sectional view illustrating a fastening member in the unit cooler according to the embodiment.

FIG. 8 is an enlarged cross-sectional view illustrating an attaching portion to the forklift truck in the unit cooler according to the embodiment.

FIG. 9 is a cross-sectional view similar to FIG. 6, illustrating a structure and an under cover in a unit cooler according to a first modified example.

FIG. 10 is a cross-sectional view similar to FIG. 6, illustrating a structure and an under cover in a unit cooler according to a second modified example.

FIG. 11 is a plan view illustrating a headguard and the unit cooler according to the embodiment in another forklift truck.

FIG. 12 is a perspective view illustrating the headguard and the unit cooler of the forklift truck in FIG. 11 as viewed from a front of them.

FIG. 13 is a plan view similar to FIG. 11 in a case where a mounted position of the unit cooler according to the embodiment is changed.

FIG. 14 is a plan view similar to FIG. 11 in a case where the mounted position of the unit cooler according to the embodiment is further changed.

### DESCRIPTION OF EMBODIMENTS

### Embodiment

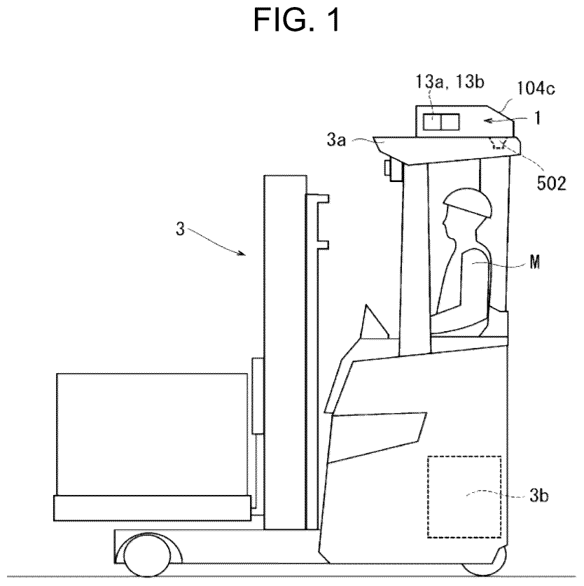

The following will describe an embodiment according to the present invention with reference to accompanying drawings. As illustrated in FIG. 1, a unit cooler 1 of the embodiment is fixed to a headguard 3a of a reach-type electric forklift truck 3 as the industrial vehicle. The forklift truck 3 has a battery 3b as the power source. When a driver M operates the forklift truck 3, the forklift truck 3 travels and performs cargo handling work by power supplied from the battery 3b.

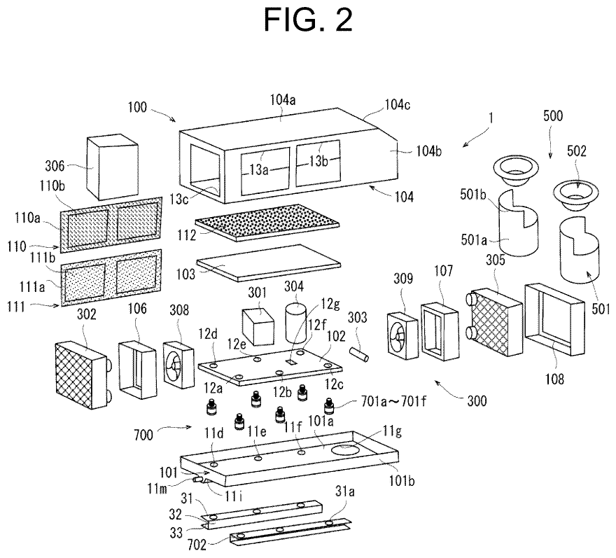

This unit cooler 1, as illustrated in FIG. 2, includes a housing 100, an air conditioner 300, and a cold air guiding portion 500. The housing 100 has an under cover 101, a base plate 102, an upper plate 103, and a top cover 104.

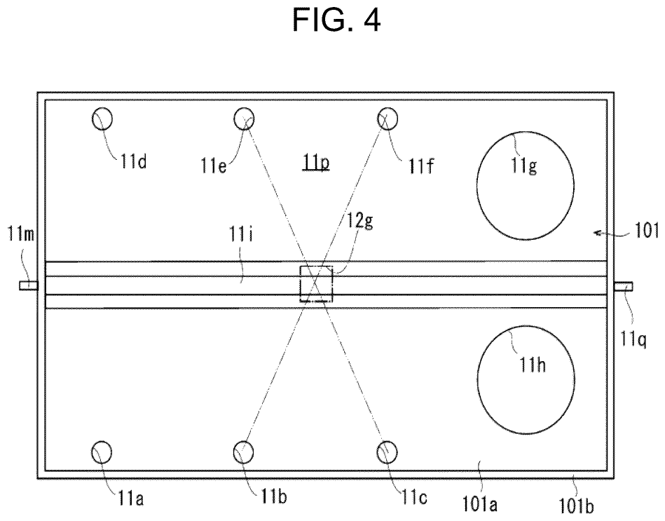

The under cover 101 is made of metal. The under cover 101 includes a bottom plate 101a formed in a rectangular shape and a peripheral wall 101b extending upward from four sides of the bottom plate 101a and connected to each other. Six bolt holes 11a to 11f and two ventilation ports 11g, 11h extend through the bottom plate 101a, as illustrated in FIG. 4. In FIG. 4, in a left area of the bottom plate 101a relative to a center thereof, three of the bolt holes 11a to 11f are formed along one long side of the bottom plate 101a and the remaining three of the bolt holes 11a to 11f are formed along the other long side of the bottom plate 101a. The ventilation ports 11g, 11h are formed on upper and lower portions of the bottom plate 101a in a right area of the bottom plate 101a. The three bolt holes 11a to 11c along the one long side are arranged at regular intervals, and the three bolt holes 11d to 11f along the other long side are also arranged at regular intervals. Note that the bolt hole 11b may be located close to the bolt hole 11a or the bolt hole 11c, and the bolt hole 11e may be located close to the bolt hole 11d or the bolt hole 11f.

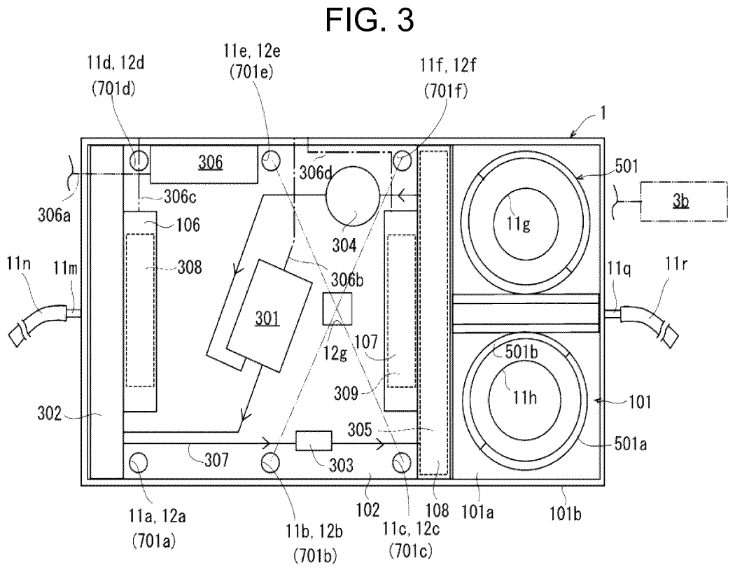

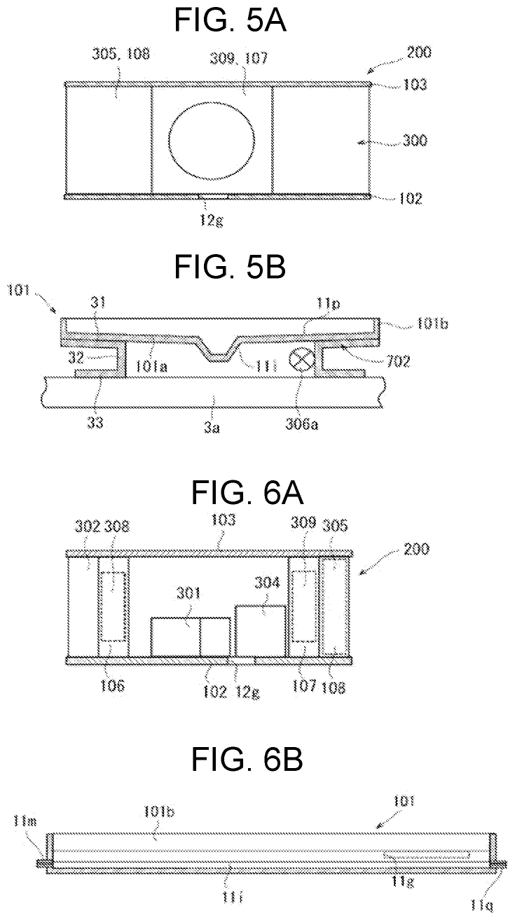

In a bottom plate 101a, a drain groove 11i is formed so as to extend from a midpoint of one short side of the bottom plate 101a to a midpoint of the other short side of the bottom plate 101a in parallel with long sides of the bottom plate 101a. The drain groove 11i is a part of the bottom plate 101a formed in a gutter shape. In addition, as illustrated in FIG. 5, a top surface of the bottom plate 101a is an inclined surface 11p that inclines downward toward the drain groove 11i. The drain groove 11i corresponds to a drain passage. In both ends of the drain groove 11i, pipes 11m, 11q extend through the peripheral wall 101b. As illustrated in FIG. 3, the pipes 11m, 11q are connected to the drain hoses 11n, 11r, respectively, that lead to the outside of the housing 100 without interfering. Note that the pipes 11m, 11q may be formed in the bottom wall of the drain groove 11i.

The base plate 102 is made of metal. As illustrated in FIG. 2, the base plate 102 is a flat plate formed in a rectangular shape whose long sides are shorter than those of the bottom plate 101a of the under cover 101. Six bolt holes 12a to 12f, which are aligned with the bolt holes 11a to 11f of the under cover 101, extend through the base plate 102. In FIG. 3, three of the bolt holes 12a to 12f are formed along one long side of the base plate 102 and the remaining three of the bolt holes 12a to 12f are formed along the other long side of the base plate 102.

As illustrated in FIG. 3 and FIG. 4, a through hole 12g extends through almost a center of the base plate 102. The through hole 12g is located at a position that is overlapped with an intersection point of diagonal lines connecting four bolt holes, 11b, 12b, 11c, 12c, 11e, 12e, 11f, 12f, which are located around the through hole 12g. The through hole 12g is equally spaced from each of the bolt holes 11b, 12b, 11c, 12c, 11e, 12e, 11f, 12f. As illustrated in FIG. 4 to FIG. 6, the drain groove 11i of the under cover 101 is located under the through hole 12g. The drain groove 11i is disposed at a predetermined distance from each of the bolt holes 11a to 11f. A plurality of bolt holes, which is not illustrated, extends through the base plate 102 and is used for fixing a first case 106, an electric compressor 301, an accumulator 304, a second case 107, and a third case 108, which will be described later.

The upper plate 103 is made of metal. As illustrated in FIG. 2, the upper plate 103 is also a flat plate formed in a rectangular shape. The upper plate 103 is disposed between the top cover 104 and the base plate 102. The upper plate 103 does not have bolt holes such as the bolt holes 12a to 12f of the base plate 102. A plurality of bolt holes, which is not illustrated, extends through the upper plate 103 and is used for fixing the first case 106 and the second case 107, which will be described later.

The top cover 104 is made of metal. The top cover 104 has a top plate 104a formed in a rectangular shape, an inclined plate 104c inclining downwards from one end of the top plate 104a, and a peripheral wall 104b extending downwards from three sides of the inclined plate 104c and from three sides of the top plate 104a and connected to each other. The top plate 104a is thicker than the bottom plate 101a of the under cover 101 by the thickness of the top cover 104. The top cover 104 is fixed to the under cover 101 with bolts, which are not illustrated.

The peripheral wall 104b of the top cover 104 has two suction ports 13a, 13b located in one long side of the top plate 104a and a heat releasing port 13c located in one short side of the top plate 104a adjacently to the suction port 13a. A first filter 110 and a second filter 111 are attachable to the suction ports 13a, 13b. The heat releasing port 13c is located opposite to the inclined plate 104c across the top plate 104a.

The first filter 110 includes a first frame 110a that is fixed to the peripheral wall 104b of the top cover 104 and a metal mesh 110b. Two openings, which are aligned with the suction ports 13a, 13b, extend through the first frame 110a. The metal mesh 110b is fixed to the first frame 110a so as to cover both the openings.

The second filter 111 includes a second frame 111a that is fixed to the peripheral wall 104b of the top cover 104 and a sponge 111b. Two openings, which are aligned with the suction ports 13a, 13b, extend through the second frame 111a. The sponge 111b is removably attached to the second frame 111a so as to cover both the openings. The first filter 110 and the second filter 111 are also a part of the housing 100.

The air conditioner 300 has the electric compressor 301, a condenser 302, an expansion valve 303, the accumulator 304, an evaporator 305, and a control device 306. The expansion valve 303 corresponds to a decompression device. As illustrated in FIG. 3, the electric compressor 301, the condenser 302, the expansion valve 303, the evaporator 305, and the accumulator 304 are connected in this order by pipes 307 and they form a refrigeration cycle through which a refrigerant circulates. The condenser 302 and the evaporator 305 are the same rectangular parallelepiped shape. A first fan 308 is disposed on the condenser 302 near the electric compressor 301, that is, on one end of the base plate 102, and a second fan 309 is disposed on the evaporator 305 near the accumulator 304, that is, on the other end of the base plate 102. The second fan 309 is disposed on the evaporator 305 near the electric compressor 301. The first fan 308 and the second fan 309 are also a part of the air conditioner 300. The through hole 12g of the base plate 102 is located close to the second fan 309.

The control device 306 includes a harness 306a and connecting cords 306b, 306c, 306d. The harness 306a passes along the backside of the under cover 101 and is connected to the battery 3b in the forklift truck 3. The control device 306 is fixable on the base plate 102.

The connecting cord 306b is connected to the electric compressor 301, so that the electric compressor 301 is operated by the control device 306 to circulate the refrigerant in the air conditioner 300. The connecting cord 306c is connected to the first fan 308, and the connecting cord 306d is connected to the second fan 309. Outside air is sucked into the top cover 104 from the suction ports 13a, 13b through a first filter 110 and a second filter 111 by the first fan 308 and the second fan 309 that are operated by the control device 306. The first fan 308 supplies the air in the top cover 104 to the condenser 302. The second fan 309 supplies the air in the top cover 104 to the evaporator 305.

As illustrated in FIG. 2, the condenser 302 is fixed to the first case 106. The first fan 308 is accommodated in the first case 106. The evaporator 305 is fixed to the second case 107. The second fan 309 is accommodated in the second case 107. A fan shroud is formed of the first case 106 and the second case 107. The evaporator 305 is accommodated in the third case 108. The first to third cases 106 to 108 are each formed in a rectangular parallelepiped shape. The first case 106 and the second case 107 have the same shape and are smaller than the third case 108. The first to third cases 106 to 108 also correspond to a part of the housing 100. The first case 106 is made of metal. The second case 107 is made of metal. The third case 108 is made of resin. The first case 106 and the second case 107, for example, are made of stainless steel.

As illustrated in FIG. 3 and FIG. 4, the first case 106 in which the first fan 308 is accommodated, the electric compressor 301, the accumulator 304, the second case 107 in which the second fan 309 is accommodated, and the control device 306 are fixed to a top surface of the base plate 102 with the bolts or the like, which are not illustrated. After this, the electric compressor 301, the condenser 302, the expansion valve 303, the accumulator 304, and the evaporator 305 are connected by the pipes 307, and the refrigerant is sealed therein. In addition, the upper plate 103 is fixed to the first case 106 and the second case 107 with bolts or the like, which are not illustrated. Thus, as illustrated in FIG. 5 and FIG. 6, the base plate 102, the upper plate 103, and the air conditioner 300 are integrated to form a structure 200.

As illustrated in FIG. 2, the cold air guiding portion 500 is formed of an inner surface of the top cover 104, in particular, an inner surface of the inclined plate 104c, the two ventilation ports 11g, 11h of the under cover 101, two shades 501, and two punkah-louvers 502. The shades 501 are each fixed around a corresponding one of the ventilation ports 11g, 11h in the under cover 101 together with the punkah-louver 502 with bolts, which are not illustrated, so as to face the third case 108 in which the evaporator 305 is accommodated.

Each of the shades 501 includes a cylindrical portion 501a that is formed in a cylindrical shape extending in a vertical axial direction of the shade 501, and an eaves portion 501b that is formed in an arc shape integrally with the cylindrical portion 501a in an upper portion of the shade 501 in the axial direction. The outer surface of each of the eaves portion 501b faces the evaporator 305 and causes the cold air to detour into the cylindrical portion 501a when the cold air sent from the evaporator 305 blows onto the outer surface.

Each of the punkah-louvers 502 is disposed in a lower portion of the cylindrical portion 501a of a corresponding one of the shades 501 in the axial direction thereof. An air outlet of each of the punkah-louvers 502 is turned, and the cold air is sent to the driver from the air outlet of the punkah-louver 502.

The unit cooler 1 is assembled to the forklift truck 3 by a fastening means 700 and fixed to the forklift truck 3. The fastening means 700 includes six fastening members 701a to 701f, two under rails 702 each formed in a U-shape with corners at right angles when viewed in a cross section, a plurality of bolts 703, and a plurality of nuts 704.

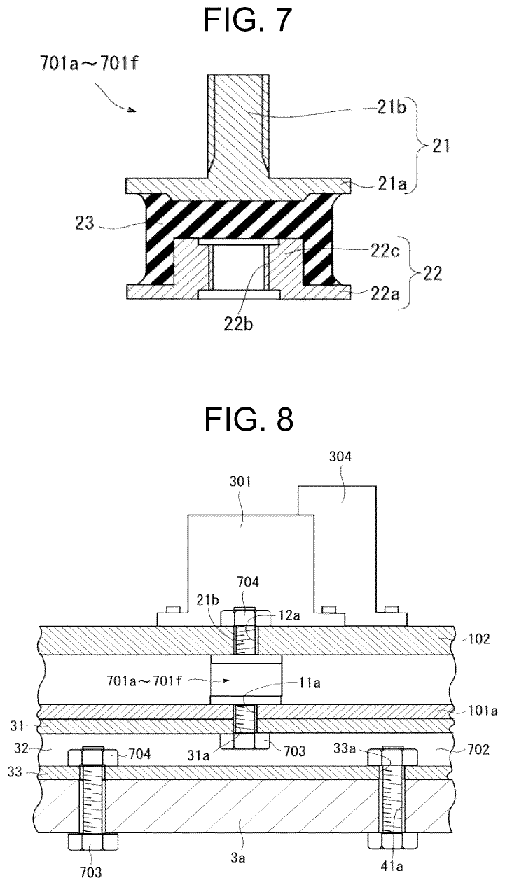

The fastening members 701a to 701f, as illustrated in FIG. 7, are each formed of a first member 21, a second member 22, and a middle member 23. The first member 21 includes a circular plate portion 21a having a circular plate shape and an external screw portion 21b that is integrally formed with the circular plate portion 21a and extends in an axial direction perpendicular to the circular plate portion 21a from the center of the circular plate portion 21a. The second member 22 includes a circular plate portion 22a having a circular plate shape and a boss portion 22c that is integrally formed with the circular plate portion 22a and extends in the same direction as a direction in which the external screw portion 21b extends from the center of the circular plate portion 22a and in which an internal screw portion 22b is formed. The middle member 23 is made of natural rubber having an insulation property and a vibration isolating property. The middle member 23 connects the circular plate portion 21a of the first member 21 to the circular plate portion 22a and the boss portion 22c of the second member 22. The middle member 23 corresponds to an insulation member.

As illustrated in FIG. 2, each of the under rails 702 is formed of an upper rail plate 31, a lower rail plate 33, and a side rail plate 32 connecting the upper rail plate 31 to the lower rail plate 33. Three bolt holes 31a, which are aligned with the bolt holes 11a to 11f of the bottom plate 101a in the under cover 101, extend through the upper rail plate 31. As illustrated in FIG. 5, the upper rail plate 31 is inclined similarly to the bottom plate 101a of the under cover 101. In addition, the under cover 101 is held above the headguard 3a of the forklift truck 3 through the pair of the under rails 702, so that the drain groove 11i of the under cover 101 does not interfere with the headguard 3a.

As illustrated in FIG. 8, bolt holes 41a of the suitable number extends vertically through the headguard 3a of the forklift truck 3. A bolt hole 33a, which is aligned with the bolt hole 41a of the headguard 3a, extends through the lower rail plate 33 of the under rails 702. As illustrated in FIG. 5, the harness 306a is guided to a rear of the forklift truck 3 along the under rails 702 near the control device 306 on the backside of the under cover 101. In this case, for example, the harness 306a is held to the side rail plate 32 by a holding member, which is not illustrated.

In a case where the unit cooler 1 is fixed to the forklift truck 3, as illustrated in FIG. 5 and FIG. 6, first, the structure 200 is prepared. In addition, the shades 501 and the punkah-louvers 502 are fixed to the under cover 101. Then, as illustrated in FIG. 8, the two under rails 702 are fixed to the headguard 3a of the forklift truck 3 with the bolts 703 and the nuts 704, and the under cover 101 is mounted on the under rails 702.

In this state, the bolts 703 are inserted into the bolt holes 31a and the bolt holes 11a to 11f and screwed into the internal screw portions 22b of the fastening members 701a to 701f. Here, the fastening members 701a to 701f include the first fastening members 701a, 701d, the second fastening members 701c, 701f, and the third fastening members 701b, 701e. The first fastening member 701a is disposed in the bolt hole 11a of the under cover 101 and the bolt hole 12a of the base plate 102, and the first fastening member 701d is disposed in the bolt hole 11d of the under cover 101 and the bolt hole 12d of the base plate 102. The first fastening members 701a, 701d are disposed with the first fan 308 interposed therebetween. The second fastening member 701c is disposed in the bolt hole 11c of the under cover 101 and the bolt hole 12c of the base plate 102, and the second fastening member 701f is disposed in the bolt hole 11f of the under cover 101 and the bolt hole 12f of the base plate 102. The second fastening members 701c, 701f are disposed with the second fan 309 interposed therebetween. The third fastening member 701b is disposed in the bolt hole 11b of the under cover 101 and the bolt hole 12b of the base plate 102, and the third fastening member 701e is disposed in the bolt hole 11e of the under cover 101 and the bolt hole 12e of the base plate 102. The third fastening members 701b, 701e are disposed with the electric compressor 301 interposed therebetween.

The through hole 12g is open at a position that is overlapped with an intersection point of diagonal lines connecting the second fastening members 701c, 701f and the third fastening members 701b, 701e. The accumulator 304 is located in a region surrounded by the second fastening members 701c, 701f and the third fastening members 701b, 701e.

When the under cover 101 and the under rails 702 are fixed with the fastening members 701a to 701f, the external screw portions 21b of the fastening members 701a to 701f are inserted into the bolt holes 12a to 12f of the base plate 102, and the nuts 704 are screwed onto the external screw portion 21b. Even when the under cover 101 is relatively thin, the under cover 101 is firmly fixed to the headguard 3a.

In addition, as illustrated in FIG. 3, the connecting cords 306b, 306c, 306d of the control device 306 are connected to the electric compressor 301, the first fan 308, and the second fan 309, respectively. Afterwards, sponge rubber 112, which is illustrated in FIG. 2, is placed on the structure 200, the top cover 104 is placed on the under cover 101, and the top cover 104 is fixed on the under cover 101 with a bolt, which is not illustrated. The unit cooler 1 of the embodiment is mounted on the headguard 3a of the forklift truck 3 as described above. Note that after all components illustrated in FIG. 2 may be assembled to each other and the under rails 702 may be fixed to the under cover 101, the under rails 702 may be fixed to the headguard 3a of the forklift truck 3.

In this unit cooler 1, in the forklift truck 3 that does not have as many means for reducing vibrations as a passenger car, the electric compressor 301, the first fan 308, and the second fan 309 of the air conditioner 300 are operated by the battery 3b. Thus, warm air is exhausted from the condenser 302 and discharged from the heat releasing port 13c to the outside of the unit cooler 1. Furthermore, cold air flows from the evaporator 305, passes through the shades 501, and is blown out from the punkah-louvers 502 toward the driver M. At this time, the inner surface of the top cover 104, in particular, the inner surface of the inclined plate 104c suitably rectifies the cold air toward the punkah-louvers 502. The driver M may change the direction in which the cold air flows out of the punkah-louvers 502 as desired, such as toward the base of the driver M's neck, by changing the direction of the air outlet of each of the punkah-louvers 502.

In this unit cooler 1, the through hole 12g is formed in the base plate 102 to the top surface of which the air conditioner 300 is fixed. The drain groove 11i is formed in the under cover 101 that is disposed under the base plate 102. Thus, when the condensation water is generated in the air conditioner 300, the condensation water drops onto the under cover 101 from the base plate 102 through the through hole 12g and flows to the drain groove 11i of the under cover 101.

In particular, the through hole 12g is equally spaced from the second fastening members 701c, 701f and the third fastening members 701b, 701e, which are located around the through hole 12g. Even when a large amount of the condensation water is generated in the air conditioner 300, the condensation water hardly flows to the second fastening members 701c, 701f and the third fastening members 701b, 701e, and the condensation water easily drops into the drain groove 11i of the under cover 101 through the through hole 12g. Thus, the condensation water does not flow to the first to third fastening members 701a to 701f.

In addition, the under cover 101 includes the inclined surface 11p. The inclined surface 11p inclines so that a distance between the base plate and the inclined surface 11p at a position is increased as the position in the inclined surface 11p becomes closer to the drain groove 11i. The inclined surface 11p is inclined further away from the base plate 102 as the inclined surface extends from each of the bolt holes 11a, 11b, 11c, 11d, 11e, 11f toward the drain groove 11i. The condensation water dropped through the through hole 12g flows along the inclined surface 11p by its own weight and is collected in the drain groove 11i. The condensation water collected in the drain groove 11i is discharged to the outside of the housing through the pipes 11m, 11q and the drain hoses 11n, 11r.

Accordingly, this unit cooler 1 may supply cold air to the driver M of the forklift truck 3, and in the unit cooler 1, there is no risk of an electric current flowing toward the forklift truck 3 even when the condensation water is generated in the air conditioner 300.

Also, in this unit cooler 1, each of the fastening members 701a to 701f includes the middle member 23, and the middle member 23 has the vibration isolating property. This suppresses that the vibrations generated while the forklift truck 3 travels or operates are transmitted to the air conditioner 300 on the base plate 102 to reduce failures of the air conditioner 300, and this absorbs the vibrations of the air conditioner 300 to also contribute to quietness. The sponge rubber 112 that is disposed between the upper plate 103 and the top cover 104 also contributes to this quietness.

Furthermore, in this unit cooler 1, the first member 21 of each of the fastening members 701a to 701f is fixed to the base plate 102 to the top surface of which the air conditioner 300 is fixed. The second member 22 of each of the fastening members 701a to 701f is fixed to the under rails 702 with the under cover 101 interposed therebetween. The under rails 702 are fixed to the headguard 3a of the forklift truck 3. The middle member 23 connects the first member 21 to the second member 22 and has the insulation property. For this reason, even in a case of an electric leakage from the air conditioner 300, the electric current may flow only to the base plate 102 and the first member 21, and does not flow to the middle member 23, the second member 22, and the forklift truck 3.

In addition, in this unit cooler 1, since the accumulator 304 is located in a region surrounded by the second fastening members 701c, 701f and the third fastening members 701b, 701e, an unnecessary space is less likely to be generated in the housing 100, which decreases the unit cooler 1 in size.

Also, in this forklift truck 3, as illustrated in FIG. 1, the suction ports 13a, 13b of the unit cooler 1 are located above the headguard 3a, so that noise from the unit cooler 1 hardly disturbs the driver M. In addition, the suction ports 13a, 13b of the unit cooler 1 are located on a left end side of the headguard 3a, so that the first filter 110 and the second filter 111 are easily maintained or inspected.

Furthermore, in this forklift truck 3, the unit cooler 1 is formed in a rectangular shape having longitudinal sides extending in a front-rear direction, the unit cooler 1 is low in height, and the heat releasing port 13c is located at the front end of the headguard 3a, so that the warm air does not blow onto the driver M.

Moreover, by removing the bolt 703 and the nut 704 and performing the above operations in reverse, this unit cooler 1 may be mounted on other industrial vehicles.

### First Modified Example

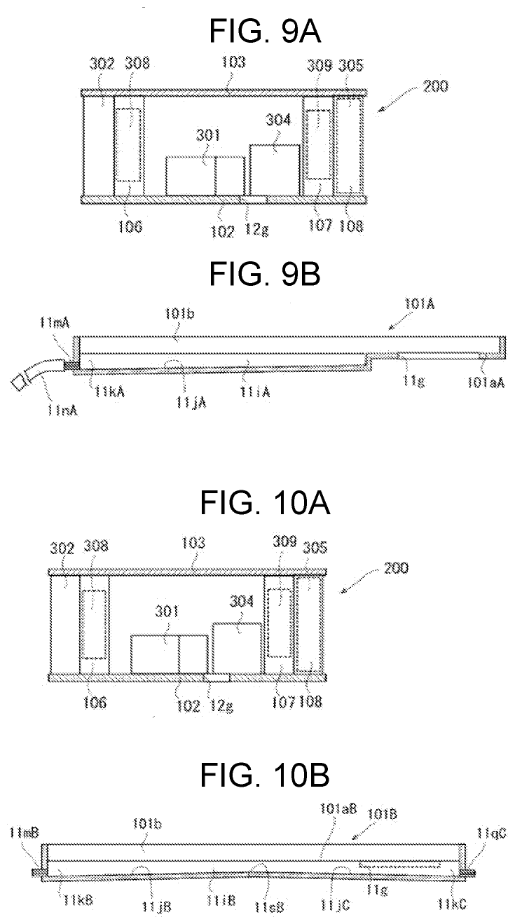

In the unit cooler of a first modified example, an under cover 101A is adopted, which is illustrated in FIG. 9. In the under cover 101A, a top surface of a bottom plate 101aA is flat and a drain groove 11iA is formed in a left area of the bottom plate 101aA relative to a center thereof. A top surface of the drain groove 11iA is an in-path inclined surface 11jA that inclines downward as it extends away from the ventilation ports 11g, 11h. The most downstream portion of the drain groove 11iA is defined as a sump portion 11kA, and a pipe 11mA extends from the sump portion 11kA so as to extend through a peripheral wall 101b. The pipe 11mA is connected to a drain hose 11nA that leads to the outside of the housing without interfering. The other components are the same as those in the first embodiment.

In this unit cooler, the drain groove 11iA includes the in-path inclined surface 11jA. The condensation water dropped through the through hole 12g flows over the upper surface of the bottom plate 101aA, and then, flows along the in-path inclined surface 11jA by its own weight to be collected in the sump portion 11kA. The condensation water collected in the sump portion 11kA is discharged to the outside of the housing through the pipe 11mA and the drain hose 11nA.

### Second Modified Example

In the unit cooler of a second modified example, an under cover 101B illustrated in FIG. 10 is adopted. In the under cover 101B, a top surface of a bottom plate 101aB is flat and a drain groove 11iB is formed so as to extend from one end to the other end in the bottom plate 101aB. The top surface of the drain groove 11iB includes in-path inclined surfaces 11jB, 11jC that incline downward as they extend away from each other from a center position 11sB of the long side of the bottom plate 101aB. The two most downstream portions in the drain groove 11iB correspond to sump portions 11kB, 11kC, and pipes 11mB, 11qC are provided in the sump portions 11kB, 11kC respectively so as to extend through the peripheral wall 101b. Each of the pipes 11mB, 11qC is connected to a drain hose that leads to the outside of the housing without interfering and is not illustrated. The other components are the same as those in the first embodiment.

In this unit cooler, the drain groove 11iB includes the in-path inclined surfaces 11jB, 11jC. The condensation water dropped through the through hole 12g flows over the upper surface of the bottom plate 101aB, and then, flows along the in-path inclined surfaces 11jB, 11jC by its own weight to be collected in the sump portions 11KB, 11kC, respectively. The condensation water collected in the sump portions 11kB, 11kC is discharged to the outside of the housing through the pipes 11mB, 11qC and the drain hoses.

Although the present invention has been described above based on the embodiment, the first modified example, and the second modified example, the present invention is not limited to the embodiment, the first modified example, and the second modified example, and may be modified as appropriate within a gist of the present invention.

For example, the unit cooler of the present invention may be used in an electric forklift truck of a counter type, a picking type, a 3-way type, or a refrigerator-freezer type, and may be widely used in industrial vehicles such as various engine forklift trucks, transportation equipment, or towing trucks.

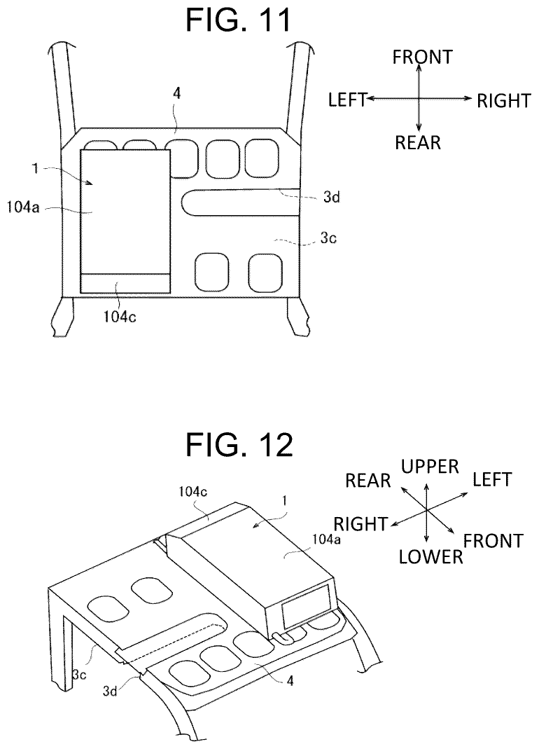

For example, in the counter type electric forklift truck, as illustrated in FIG. 11 and FIG. 12, a cutout 3d for hanging the battery may be formed in the headguard 3c. In order to prevent the unit cooler 1 from overlapping with the cutout 3d, the condenser 302 and the evaporator 305, which are relatively large components in the refrigeration cycle, are positioned at both ends of the unit cooler 1 with their long sides aligned with the short sides of the unit cooler 1, and the other components forming the refrigeration cycle, such as the electric compressor 301, the expansion valve 303, or the accumulator 304 are accommodated between the condenser 302 and the evaporator 305. Thus, these components forming the refrigeration cycle are unitized. In this case, since the unit cooler 1 of the embodiment is formed in the rectangular shape having the longitudinal sides in the front-rear direction, the unit cooler 1 may be mounted on the left side of the cutout 3d, that is, the unit cooler 1 may be mounted so as to avoid the cutout 3d. Even when a cover 4 made of transparent resin is disposed on the headguard 3c, the unit cooler 1 is miniaturized so as not to cover the whole cover 4, so that the unit cooler 1 does not interfere with the diagonal upper field of vision of the driver M.

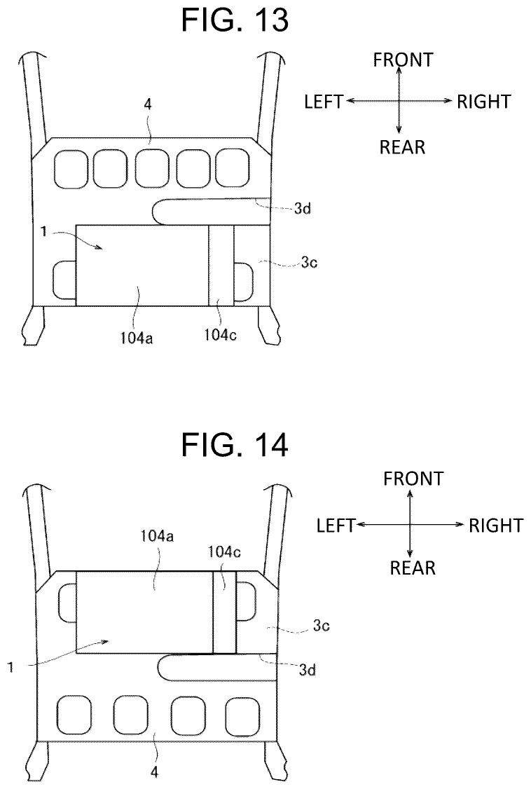

In addition, the mounted state of this unit cooler 1 is not limited to one in which the unit cooler 1 is mounted on the headguard 3c so as to extend in a front-rear direction of the headguard 3c. For example, as illustrated in FIG. 13, this unit cooler 1 may be mounted behind the cutout 3d so as to extend in a left-right direction of the headguard 3c. Alternately, as illustrated in FIG. 14, this unit cooler 1 may be mounted in front of the cutout 3d so as to extend in the left-right direction of the headguard 3c. In these cases, it is determined as desired whether the heat releasing port 13c and the inclined plate 104c are located on the left side or the right side of the headguard 3c.

The anti-vibration member of the unit cooler in the present invention is not limited to the fastening members 701a to 701f described above. The anti-vibration member of the unit cooler in the present invention may be the first member or the second member having the external screw portion or having the internal screw portion.

### INDUSTRIAL APPLICABILITY

The present invention is applicable to a unit cooler mountable on industrial vehicles or the like as an option.

### REFERENCE SIGNS LIST

11i, 11iA, 11iB drain groove (drain passage)
11jA, 11jB, 11jC in-path inclined surface
11p inclined surface
12g through hole
23 middle member (insulation member)
100 housing
101, 101A, 101B under cover
102 base plate
300 air conditioner
301 electric compressor
302 condenser
303 expansion valve (decompression device)
304 accumulator
305 evaporator
306 control device
308 first fan
309 second fan
701a to 701f fastening members (701a, 701d first fastening members; 701b, 701e second fastening members; 701c, 701f third fastening members)

1-7. (canceled)

8. A unit cooler comprising:
a housing; and
an air conditioner that is accommodated in the housing and forms a refrigeration cycle, the air conditioner cooling air and supplying the air to an outside of the housing, wherein
the housing has:
a base plate to which the air conditioner is fixed, the base plate having a through hole through which condensation water generated in the air conditioner is discharged; and
an under cover that is disposed under the base plate and fastened to an outer peripheral portion of the base plate with a plurality of fastening members through an insulation member,
a drain passage is recessed in the under cover and located under the through hole, the drain passage guiding the condensation water to an outside of the housing,
the drain passage is disposed at a predetermined distance from each of the plurality of the fastening members,
the air conditioner has an electric compressor, a condenser, a decompression device, an evaporator, a first fan that sends air to the condenser, a second fan that sends air to the evaporator, and a control device that controls the electric compressor, the first fan, and the second fan,
the first fan adjacent to the condenser is disposed at one end of the base plate,
the second fan adjacent to the evaporator is disposed at the other end of the base plate,
the electric compressor is disposed between the first fan and the second fan,
the fastening members include:
a pair of first fastening members that is disposed with the first fan interposed between the first fastening members;
a pair of second fastening members that is disposed with the second fan interposed between the second fastening members; and
a pair of third fastening members that is disposed with the electric compressor interposed between the third fastening members, and
the through hole is open at a position that is overlapped with an intersection point of diagonal lines connecting the second fastening members and the third fastening members.

9. The unit cooler according to claim 8, wherein
the under cover has an inclined surface that inclines so that the condensation water is guided from a side of each of the fastening members toward the drain passage.

10. The unit cooler according to claim 9, wherein
the drain passage extends to at least one of ends of the under cover.

11. The unit cooler according to claim 10, wherein
the drain passage has an in-path inclined surface that guides the condensation water dropped through the through hole to the end of the under cover.

12. The unit cooler according to claim 8, wherein
the insulation member is made of rubber material having a vibration isolating property.

13. The unit cooler according to claim 8, wherein
the air conditioner has an accumulator, and
the accumulator is located in a region surrounded by the second fastening members and the third fastening members.
